(19) United States
(12) Patent Application Publication
(10) Pub. No.: US 2012/0199164 A1
(43) Pub. Date: Aug. 9, 2012

(54) Methods for Using Proximity Head With Configurable Delivery

(76) Inventors: Mark H. Wilcoxson, Oakland, CA (US); Christopher J. Radin, Palo Alto, CA (US)

(21) Appl. No.: 13/452,805

(22) Filed: Apr. 20, 2012

Related U.S. Application Data
(62) Division of application No. 11/746,616, filed on May 9, 2007, now abandoned.
(60) Provisional application No. 60/871,753, filed on Dec. 22, 2006.

(51) Int. Cl. B08B 5/04; B08B 3/00

(52) U.S. Cl. 134/21

(57) ABSTRACT

A method for processing a substrate includes an operation of positioning a surface of a head proximate to a surface of the substrate. The surface of the head has a length and a plurality of ports that are configured in rows along the length of the head. Each row of ports can deliver a fluid to the surface of the substrate or deliver a vacuum to remove the fluid from the surface of the substrate. The method also includes an operation of controlling delivery of the fluid to one or more selected rows and delivery of the vacuum to one or more selected rows so that at least one meniscus is formed whose width depends on a desired exposure time of the meniscus to the surface of the substrate for a particular speed of relative movement between the head and the substrate.

### CLAIM OF PRIORITY

This application is a divisional application of U.S. patent application Ser. No. 11/746,616, entitled “Proximity Head with Configurable Delivery”, which was filed on May 9, 2007, was published on Jun. 26, 2008, as U.S. Published Patent Application No. 2008/0149147, and which claims priority from U.S. Provisional application No. 60/871,753, filed on Dec. 22, 2006. The disclosure of each of these applications is hereby incorporated herein by reference.

### BACKGROUND

1. Field of the Invention

The present invention relates generally to substrate processing and equipment, and more particularly to systems that enable flexible configurations of delivering and applying processing fluids to a surface of the substrate.

2. Description of the Related Art

In the semiconductor chip fabrication process, it is well-known that there is a need to clean and dry a wafer where a fabrication operation has been performed that leaves unwanted residues on the surfaces of wafers. Examples of such a fabrication operation include plasma etching and chemical mechanical polishing (CMP). In CMP, a wafer is placed in a holder which pushes a wafer surface against a polishing surface. A slurry consists of chemicals and abrasive materials to cause the polishing. Unfortunately, this process tends to leave an accumulation of slurry particles and residues at the wafer surface. If left on the wafer, the unwanted residual material and particles may cause, among other things, defects such as scratches on the wafer surface and inappropriate interactions between metallization features. In some cases, such defects may cause devices on the wafer to become inoperable. In order to avoid the undue costs of discarding wafers having inoperable devices, it is therefore necessary to clean the wafer adequately yet efficiently after fabrication operations that can leave unwanted residues. In addition to residues, unwanted films may be present on the wafer may also need to be removed.

After a wafer has been wet cleaned, the wafer must be dried effectively to prevent water or cleaning fluid remnants from leaving residues on the wafer. If the cleaning fluid on the wafer surface is allowed to evaporate, as usually happens when droplets form, residues or contaminants previously dissolved in the cleaning fluid will remain on the wafer surface after evaporation (e.g., and form spots). To prevent evaporation from taking place, the cleaning fluid must be removed as quickly as possible without the formation of droplets on the wafer surface.

In an attempt to accomplish this, one of several different drying techniques are employed such as spin drying, IPA, or Marangoni drying. All of these drying techniques utilize some form of a moving liquid/gas interface on a wafer surface which, if properly maintained, results in drying of a wafer surface without the formation of droplets. Unfortunately, if the moving liquid/gas interface breaks down, as often happens with all of the aforementioned drying methods, droplets form and evaporation occurs resulting in contaminants being left on the wafer surface.

In view of the forgoing, there is a need for a apparatus and methods that enable processing of fluids over substrate surfaces in a controlled manner, while enabling configuration of the fluid delivery for specific applications or equipment configurations.

### SUMMARY

In one embodiment, an apparatus for processing a substrate is disclosed. The apparatus has a proximity head having a surface that can be interfaced in proximity to a surface of a substrate. The proximity head has a plurality of dispensing ports capable of dispensing a first process mixture and a second process mixture to the surface of the substrate. The proximity head also has a plurality of removal ports capable of removing the first and second process mixtures from the surface of the substrate. The apparatus also has a distribution manifold connected to the plurality of dispensing ports for dispensing the first process mixture and second process mixture. The distribution manifold is connected to the plurality of removal ports, and is structured to define selected regions of the proximity head for delivery and removal of the first process mixture and the second process mixture.

In another embodiment, a proximity system for processing a substrate is disclosed. The proximity system has a head with a head surface that his configured to be positioned proximate to a surface of the substrate. The head has a width and a length, and has a plurality of ports configured in rows along the length of the head. The plurality of rows extend over the width of the head, and each of the plurality of ports is configured to either deliver a fluid to the surface of the substrate or remove the fluid from the surface of the substrate. A meniscus is defined between the surface of the substrate and the surface of the head when the fluid is delivered and removed. The proximity system also has a programmable distribution manifold connected to facilities. The facilities provide and receive fluids from the programmable distribution manifold. The programmable distribution manifold is connected to the head so that port conduits are interfaced between the programmable distribution manifold and the plurality of ports. The proximity system also has a controller for directing the programmable distribution manifold to deliver or remove fluids to selected ones of the plurality of ports of the head, such that a region between the surface of the head and the surface of the substrate is set for establishing the meniscus, and a size of the meniscus defined by the set region.

In yet another embodiment, a method for processing a substrate using a proximity head is disclosed. The method begins by providing a head having a head surface configured to be positioned proximate to a surface of the substrate. The head has a width and a length, and the head has a plurality of ports that are configured in rows along the length of the head. The plurality of rows extend over a width of the head and each of the plurality of ports are configured to either deliver a fluid to the surface of the substrate or remove the fluid from the surface of the substrate. Such that a meniscus is formed between the surface of the substrate and the surface of the head when the fluid is delivered and removed. The method continues by controlling access of the fluids to only selected ones of the plurality of ports. The controlling of access is configured to define a width of the meniscus between the surface of the substrate and the surface of the head.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1A shows a high-level schematic of a substrate processing assembly in accordance with one embodiment of the present invention.

FIG. 1B illustrates exemplary configurations of a proximity station as discussed with reference to FIG. 1A.

FIG. 2 is a high-level schematic illustrating a proximity head for the application and removal of fluids to the surface of a substrate in accordance with one embodiment of the present invention.

FIG. 3 is a schematic showing a cross-section of a proximity head and programmable distribution manifold in accordance with one embodiment of the present invention.

FIG. 4 is a diagram illustrating a long chemical exposure time for a substrate using a proximity head with a programmable distribution manifold in accordance with one embodiment of the present invention.

FIG. 5 is a diagram illustrating a short process exposure time using a proximity head with a programmable distribution manifold in accordance with one embodiment of the present invention.

FIG. 6A is a schematic showing the application of multiple process mixtures with different process mixture exposure times using a proximity head with a programmable distribution manifold in accordance with one embodiment of the present invention.

FIG. 6B is a schematic illustrating multiple dispensing ports supplying the same process mixture in conjunction with a removal port capable of removing only process mixture in accordance with one embodiment of the present invention.

FIG. 6C is a schematic illustrating the containment of process mixture using a single removal port in accordance with one embodiment of the present invention.

FIG. 7A is a schematic illustrating the application and recycling of multiple process mixtures using a proximity head with a programmable distribution manifold in accordance with one embodiment of the present invention.

FIG. 7B and 7C are alternate embodiments illustrating the application and recycling of multiple process mixtures using a proximity head with a programmable distribution manifold in accordance with embodiments of the present invention.

FIG. 8 illustrates an exemplary configuration of using port actuators between the source inputs and the programmable distribution manifold in accordance with one embodiment of the present invention.

FIGS. 9A-9D illustrate various configurations of menisci using various process mixtures in accordance with embodiments of the present invention.

### DETAILED DESCRIPTION

Embodiments are disclosed for an apparatus that can deliver fluids to a surface of a substrate using a meniscus. The term, “meniscus,” as used herein, refers to a volume of liquid bounded and contained in part by surface tension of the liquid. The meniscus is also controllable and can be moved over a surface in the contained shape. In specific embodiments, the meniscus is maintained by the delivery of fluids to a surface while also removing the fluids so that the meniscus remains controllable. Furthermore, the meniscus shape can be controlled by precision fluid delivery and removal systems that may further include a computing system.

In embodiments of the present invention, the meniscus is applied to a surface of a substrate with a proximity head. A proximity head is an apparatus that can receive fluids, and remove fluids from a surface of a substrate, when the proximity head is placed in close relation to the surface of the substrate. In one example, the proximity head has a head surface and the head surface is placed substantially parallel to the surface of the substrate. The meniscus is thus defined between the head surface and the surface of the substrate. Different degrees of proximity are possible, and example proximity distances may be between about 0.25 mm and about 4 mm, and in another embodiment between about 0.5 mm and about 1.5 mm. The proximity head, in one embodiment, will receive a plurality of fluid inputs and is also configured with vacuum ports for removing the fluids that were provided.

By controlling the delivery and removal of the fluids to the meniscus, the meniscus can be controlled and moved over the surface of the substrate. In some embodiments, the substrate can be moved, while the proximity head is still, and in other embodiments, the head moves and the substrate remains still, during the processing period. Further, for completeness, it should be understood that the processing can occur in any orientation, and as such, the meniscus can be applied to surfaces that are not horizontal (e.g., vertical substrates or substrates that are held at an angle).

In one embodiment, the fluid delivery to the proximity head is dynamically configurable, such that dispensing and removing of process fluids (or mixtures) can be preconfigured, depending on the desired application. A programmable distribution manifold can partly assist the configuration of a proximity head. The programmable distribution manifold can define which fluids are delivered to the proximity head and can also define where on the proximity head the fluids will be delivered. The result is that the fluids can be placed on just the desired regions of the substrate, and in desired orders. For instance, different fluid can be delivered to different parts of the proximity head, so that fluids of different types can perform different processes, one after another, as the head or substrate moves.

In one example, multiple menisci can be generated, of different sizes and placement, as configured by the programmable distribution manifold. The proximity head is also provided with a plurality of ports, so that the controlled delivery and selection of regions of the proximity is facilitated, once the fluids are directed to the proximity head from the programmable distribution manifold. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

Furthermore, dynamically configuring a proximity head can permit adjustments in substrate speed while minimizing changes to the process mixture exposure time. Similarly, changes to the substrate speed can be minimized while changing the process mixture exposure time. The use of a programmable distribution manifold can enable dynamic configuration of a proximity head. The programmable distribution manifold can accept multiple process mixture inputs and route individual process mixtures to specific dispensing ports for application to a substrate. The programmable distribution manifold can also route vacuum suction to removal ports capable of removing process mixtures from the surface of a substrate. Port actuators within the programmable distribution manifold can allow the activation and deactivation of both dispensing and removal ports. Port actuators can also be used between the source inputs and the programmable distribution manifold to facilitate the dispensing of process mixtures to the appropriate dispensing ports.

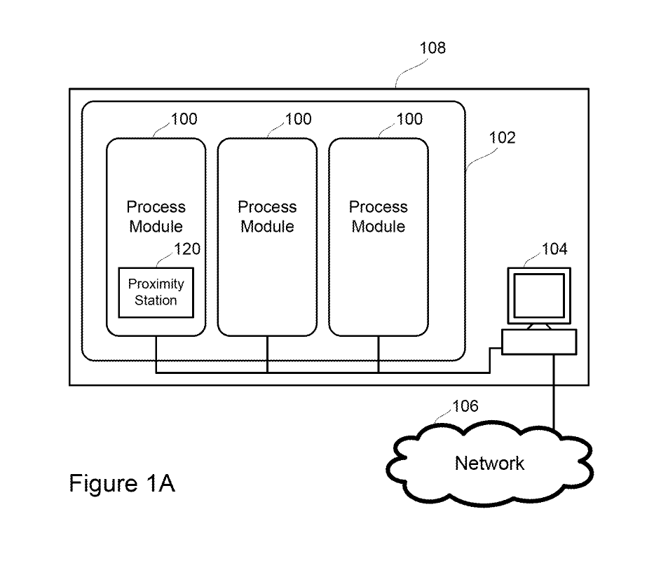

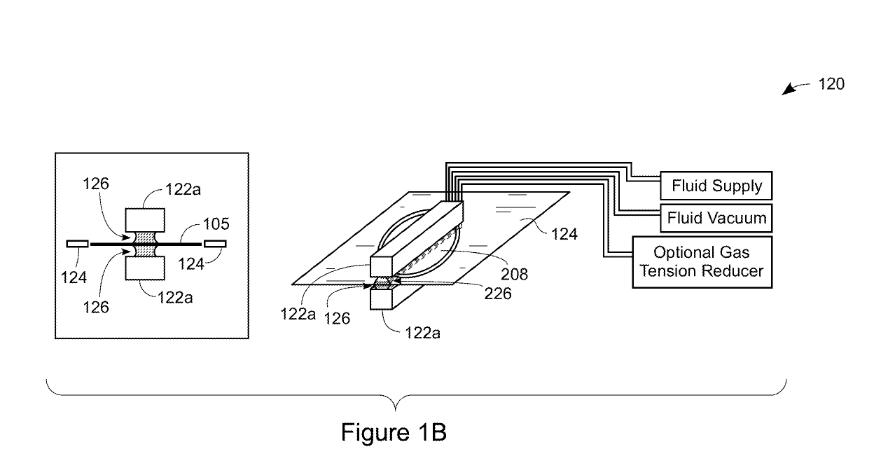

FIG. 1A shows a high-level schematic of a substrate processing assembly in accordance with one embodiment of the present invention. Clean room 108 can contain single or multiple process stations 102. Within the process station 102 there may multiple process modules 100. The process modules 100 may perform multiple substrate process operations including, but not limited to, etching, plating, cleaning, and deposition. Also found within a process station 102 and the process modules 100 are substrate transport devices capable of moving substrates between process modules and process stations. A computer 104 can control the process modules 100 and the process stations 102. The computer 104 can be networked and is capable of remote and local control of the process modules 100 and process stations 102.

In order to perform the process operations proximity stations may be found within the process modules 100. The proximity stations may include proximity heads that can be used to apply and remove process mixtures from the substrate. The proximity heads are supplied process mixtures through clean room 108 facilities directly into either the process module 100 or the process station 102. Clean room facilities are also capable of supplying a vacuum that can be used by the proximity heads to remove process mixtures from the substrate. While particular examples have been provided, these examples are not intended to be restrictive and should not be read as limitations on the claims.

FIG. 1B illustrates exemplary configurations of a proximity station 120 as discussed with reference to FIG. 1A. The proximity station 120 will include a proximity head 122a on a topside and a bottom side of the substrate 208. A carrier 124 may hold the substrate 208. Between a surface of the proximity head 122a and the surface of the substrate 208 (and surfaces of the carrier 124) a meniscus 126 is allowed to form. The meniscus 126 may be a controlled fluid meniscus that forms between the surface of a proximity head 122a and a substrate surface, and surface tension of the fluid holds the meniscus 126 in place and in a controlled form. Controlling the meniscus 126 is also ensured by the controlled delivery and removal of fluid, which enables the controlled definition of the meniscus 126, as defined by the fluid. The meniscus 126 may be used to clean, process, etch, or process the surface of the substrate 208. The processing on the substrate 208 may be such that the meniscus 126 removes particulates or unwanted materials.

The meniscus 126 is controlled by supplying a fluid to the proximity heads 122a while removing the fluid with a vacuum in a controlled manner. Optionally, a gas tension reducer may be provided to the proximity heads 122a, so as to reduce the surface tension between the meniscus 126 and the substrate 208. The gas tension reducer supplied to the proximity heads 122a allows the meniscus 126 to move over the surface of the substrate 208 at an increased speed (thus increasing throughput). Examples of a gas tension reducer may be isopropyl alcohol mixed with nitrogen (IPA/N₂). Another example of a gas tension reducer may be carbon dioxide (CO₂). Other types of gasses may also be used so long as the gasses do not interfere with the processing desired for the particular surface of the substrate 208. The embodiment shown in FIG. 1B is shown connected to a single fluid supply. Note that other embodiments of a proximity head can include multiple fluid supplies and multiple varieties of gas for tension reduction. Such a embodiment may enabling a single proximity head to apply and remove multiple process fluids using.

For more information on the formation of a meniscus and the application to the surface of a substrate, reference may be made to: (1) U.S. Pat. No. 6,616,772, issued on Sep. 9, 2003 and entitled “METHODS FOR WAFER PROXIMITY CLEANING AND DRYING”; (2) U.S. patent application Ser. No. 10/330,843, filed on Dec. 24, 2002 and entitled “MENISCUS, VACUUM, IPA VAPOR, DRYING MANIFOLD”; (3) U.S. Pat. No. 6,998,327, issued on Jan. 24, 2005 and entitled “METHODS AND SYSTEMS FOR PROCESSING A SUBSTRATE USING A DYNAMIC LIQUID”; (4) U.S. Pat. No. 6,998,326, issued on Jan. 24, 2005 and entitled “PHOBIC BARRIER MENISCUS SEPARATION AND CONTAINMENT”; (5) U.S. Pat. No. 6,488,040, issued on Dec. 3, 2002 and entitled “CAPILLARY PROXIMITY HEADS FOR SINGLE WAFER CLEANING AND DRYING”; (6) U.S. patent application Ser. No. 10/261,839, filed on Sep. 30, 2002 and entitled “METHOD AND APPARATUS FOR DRYING SEMICONDUCTOR WAFER SURFACES USING A PLURALITY OF INLETS AND OUTLETS HELD IN CLOSE PROXIMITY TO THE WAFER”; and (7) U.S. patent application Ser. No. 10/957,092, filed on Sep. 30, 2004 and entitled “SYSTEM AND METHOD FOR MODULATING FLOW THROUGH MULTIPLE PORTS IN A PROXIMITY HEAD”; each is assigned to Lam Research Corporation, the assignee of the subject application, and each is incorporated herein by reference.

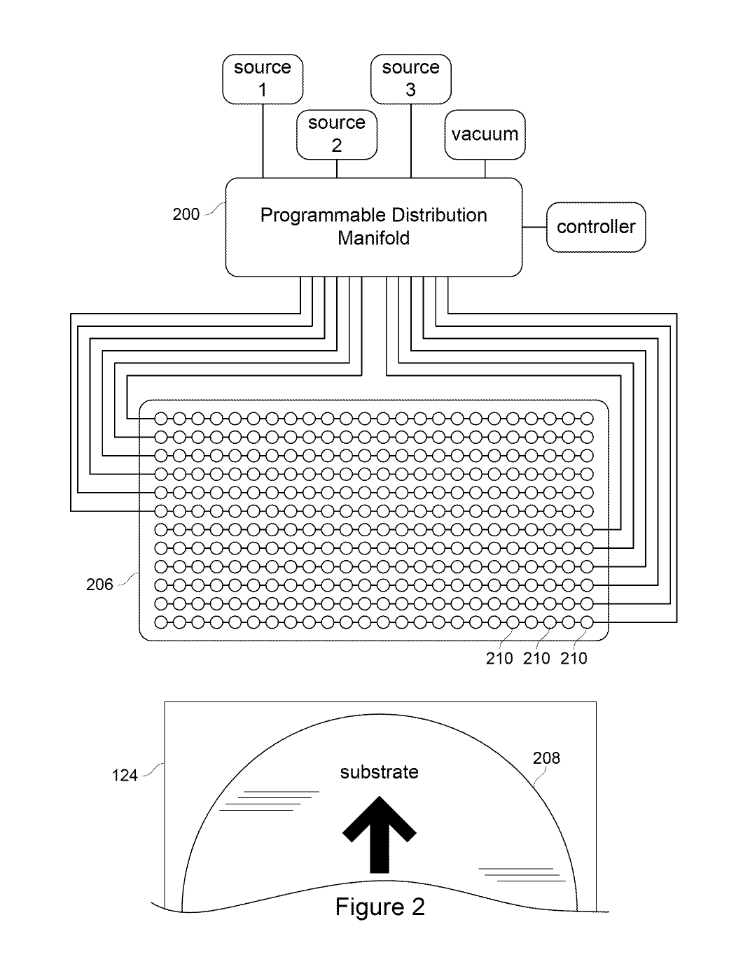

FIG. 2 is a high-level schematic illustrating a proximity head 206 for the application and removal of fluids to the surface of a substrate 208 in accordance with one embodiment of the present invention. The proximity head 206 can include multiple ports 210 that can be connected to a programmable distribution manifold 200. The programmable distribution manifold 200 can be coupled to multiple sources, shown as source 1 through source 3 and can also include a vacuum. The programmable distribution manifold 200 may also be connected to a controller 204.

Three sources are shown supplying the programmable distribution manifold 200, however, it is not intended that the programmable distribution manifold be limited to three sources. There is no minimum or maximum number of sources capable of supplying the programmable distribution manifold. The programmable distribution manifold can handle a variety of process mixtures in a variety of physical states. For example the programmable distribution manifold can input fluids, gels, foams, gases or mixtures thereof and output the process mixture to the various ports of the proximity head 206. Other sources that can be input and output by the programmable distribution manifold 200 can include de-ionized water, isopropyl alcohol, and gases such as carbon dioxide and nitrogen. A vacuum can also be attached to the programmable distribution manifold 200 allowing for the removal of material from the substrate 208. Note that while specific examples have been listed, the examples are not intended to limit the type of material or material properties of potential sources connected to the programmable distribution manifold.

The programmable distribution manifold can accept the source process mixtures and distribute the process mixtures to the proximity head 206. In one embodiment, the proximity head 206 has rows of interconnected ports 210 arranged substantially perpendicular to the direction of travel of the substrate 208. When the programmable distribution manifold is connected to the individual rows, interconnection of ports within a row can allow the application of a process mixture across the surface of the substrate 208. Alternatively, in another embodiment, each individual port of the proximity head 206 can be directly connected to the programmable distribution manifold 200. In another embodiment the programmable distribution manifold 200 can be connected to columns of interconnected ports. While specific embodiments have been discussed, the embodiments are meant to be exemplary and not intended to limit the claims. Additionally, FIG. 2 is neither intended to limit the number of ports nor the number of rows of ports of the proximity head 206. It should be understood that the number or ports across the width of the proximity head 206 is merely illustrative and alternate embodiments can contain more or fewer ports.

In one embodiment, source fluids may be dispensed through the ports 210 of the proximity head 206 as the substrate 208 passes under the ports 210. In the same or an alternate embodiment, a vacuum may be drawn through other ports or the same ports. The vacuum capable of removing fluids, solids, gases or a combination thereof, from the substrate 208. In one embodiment, the substrate travels in a direction substantially perpendicular to rows of ports 210, as shown in FIG. 2. As previously discussed, the individual ports in a row of ports can be interconnected allowing a row of ports to dispense the same fluid across the surface of the substrate 208.

In one embodiment the controller 204 can control port actuators within the programmable distribution manifold. The controller 204 can be coupled to a computer network that allows remote access and monitoring of control functions. In another embodiment the controller may be coupled to interface devices such as a monitor, keyboard and mouse allowing local control and monitoring of control functions.

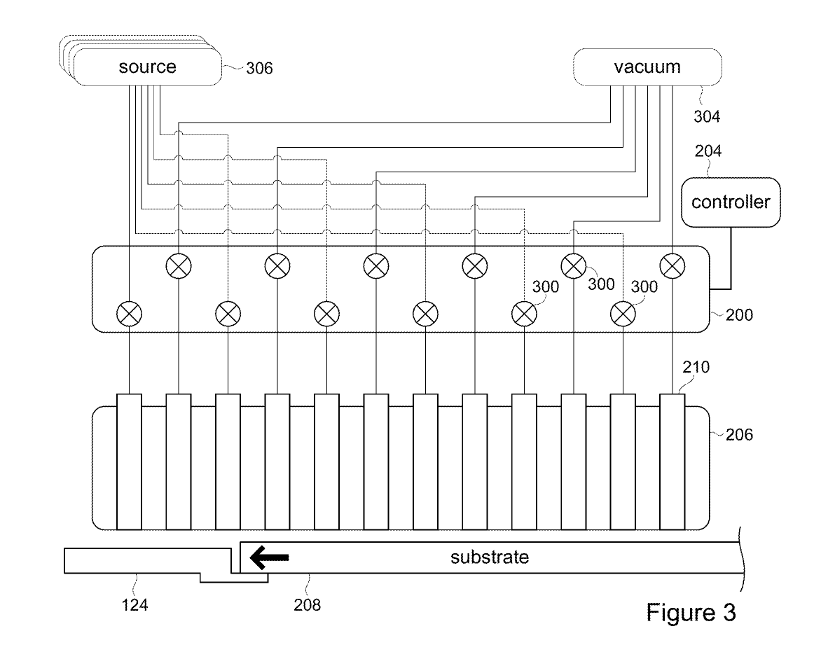

FIG. 3 is a schematic showing a cross-section of a proximity head 206 and programmable distribution manifold 200 in accordance with one embodiment of the present invention. The view illustrated in FIG. 3 is looking down the rows of interconnected ports while the substrate 208 passes adjacent to the rows of ports. For simplicity, a source 306 is shown supplying process mixtures to the programmable distribution manifold 200, however it should be understood that multiple types of process mixtures may be distributed to the programmable distribution manifold 200. Note that the port actuators 300 connected to the vacuum 304 are staggered between ports actuators 300 connected to the source 306. This configuration is shown for demonstrative purposes and should not be considered limiting. Alternate embodiments include consecutive rows or ports connected to the source or consecutive rows of ports connected to the vacuum.

Additionally, the embodiments shown in FIG. 3 through FIG. 7 illustrate the port conduits from the supplies directly connected to the port actuators 300 within the programmable distribution manifold 200. This embodiment is one technique to route process mixtures to the port actuators 300 and should not be considered limiting. Other embodiments include port actuators within the various supplies and vacuum, the port actuators can route process mixtures or vacuum suction to corresponding port actuators within the programmable distribution manifold. Additionally, the controller 204 may control the port actuators within the supplies, vacuum, and the programmable distribution manifold. This configuration can permit the controller to direct any of the variety of process mixtures and vacuum suction to any port within the proximity head 206.

In one embodiment, the source 306 and vacuum 304 are connected to the programmable distribution manifold 200. The programmable distribution manifold 200 may contain port actuators 300 that regulate flow rate of process mixtures or application of a vacuum to the substrate 208. In FIG. 3 the port actuators 300 are shown as closed so there is neither source material or process mixture nor vacuum being applied to the substrate 208. The controller 204 can be used to dynamically control the port actuators allowing for increased or decreased flow of process mixture or vacuum suction based on feedback. In another embodiment, the controller 204 can be used to dynamically change the dispensing of process mixture based on the processing requirements of a particular substrate 208.

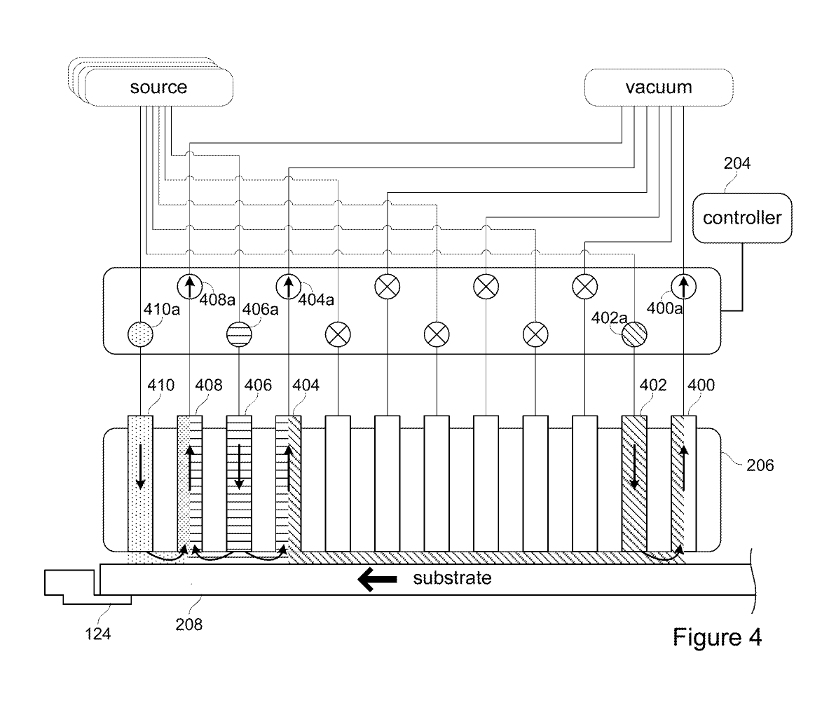

FIG. 4 is a diagram illustrating a long chemical exposure time for a substrate using a proximity head with a programmable distribution manifold in accordance with one embodiment of the present invention. As the substrate 208 passes under the proximity head 206 the substrate 208 first passes under removal port 400. As shown in FIG. 4, removal port 400 is connected to port actuator 400a that is connected to the vacuum. The vacuum drawn through port 400 can be used to remove particulate matter from the surface of the substrate 208 and to contain fluid dispensed from dispensing port 402 within the proximity head 206.

As the substrate 208 passes under dispensing port 402 a processes mixture is applied to the substrate 208. The process mixture is one of the many previously discussed process mixtures capable of being supplied from the source and routed through the programmable distribution manifold 200. In one embodiment, to reduce the amount of process mixture consumption, the controller 204 does not open the port actuator 402a until the substrate 208 is positioned adjacent to dispensing port 402. In another embodiment, the controller 204 leaves the port actuator 404a open allowing continuous flow of the process mixture to flow through dispensing port 402. The process mixture dispensed through dispensing port 402 remains on the substrate 208 until the substrate 208 encounters removal port 404. In one embodiment, the distance between the dispensing port 402 and removal port 404 can be used to define a meniscus width of the process mixture. In other embodiments, dispensing ports applying a second process mixture can contain a meniscus of a first process mixture. Removal port 404 is connected to the port actuator 404a that is connected to the vacuum. The removal port 404 can remove the process mixture from the surface of the substrate 208. Dispensing port 406, connected to port actuator 406a, can dispense de-ionized water supplied from the source to rinse the substrate 208. The removal port 404 can also draw in de-ionized water and assist in containing the de-ionized water in a defined area. Removal port 408 also removes the de-ionized water from the surface of substrate 208 and can help contain the de-ionized water within the proximity head. In one embodiment, dispensing port 410 can dispense a pressurized mixture of nitrogen and isopropyl alcohol to dry and remove possible contamination from the substrate 208. In other embodiments, contamination removal and drying of the substrate 208 may be conducted by dispensing pressurized carbon dioxide gas from dispensing port 410 onto the surface of substrate 208.

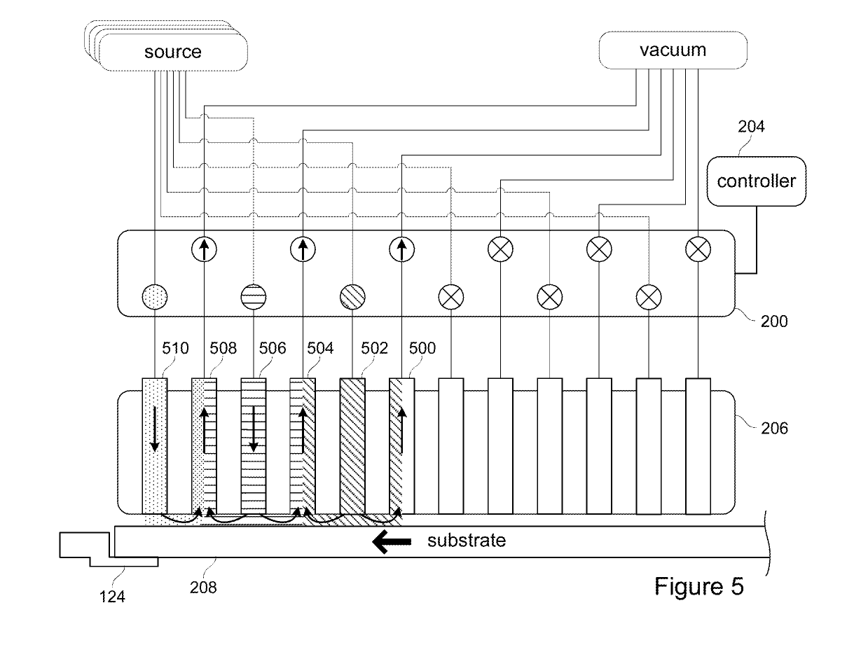

FIG. 5 is a diagram illustrating a short process exposure time using a proximity head with a programmable distribution manifold in accordance with one embodiment of the present invention. As the process mixture exposure time is short, the substrate 208 is exposed to dispensing port 502 that is surrounded by removal ports 500 and 504. Removal port 500 can remove the process mixture from the surface of substrate 208 and prevent the process mixture from spreading across the surface of the substrate 208. Removal port 504 can stop the reaction between the process mixture and the substrate 208 by removing the process mixture from the substrate 208. The removal port 504 can also remove de-ionized water introduced to rinse the surface of the substrate 208 via dispensing port 506. Subsequently, removal port 508 can also be used to vacuum the rinsing de-ionized water from the surface of the substrate 208. A curtain of pressurized gas containing a mixture of nitrogen and isopropyl alcohol can be applied to the substrate 208 from dispensing port 510 in order to dry the substrate 208. In alternate embodiments, dispensing port 510 can dispense a pressurized flow of carbon dioxide gas.

It should be noted that a single proximity head 206 connected to a programmable distribution manifold 200 can achieve both the short chemical exposure time shown in FIG. 5 and the long chemical exposure time shown in FIG. 4. The ability to activate and deactivate port actuators and route process mixtures and vacuums through the programmable distribution manifold 200 provides a user flexibility to adjust process mixture exposure times. The ability to adjust process mixture exposure time can also allow adjustment of substrate speed through the proximity head. For example, the programmable distribution manifold can compensate for an increase in substrate speed by dispensing the process mixture from an earlier dispensing port thereby providing the substrate with the same amount of process mixture exposure time. Similarly, process mixture exposure time can be modified without changing the speed of the substrate because different dispensing and removal ports can be used via the programmable distribution manifold.

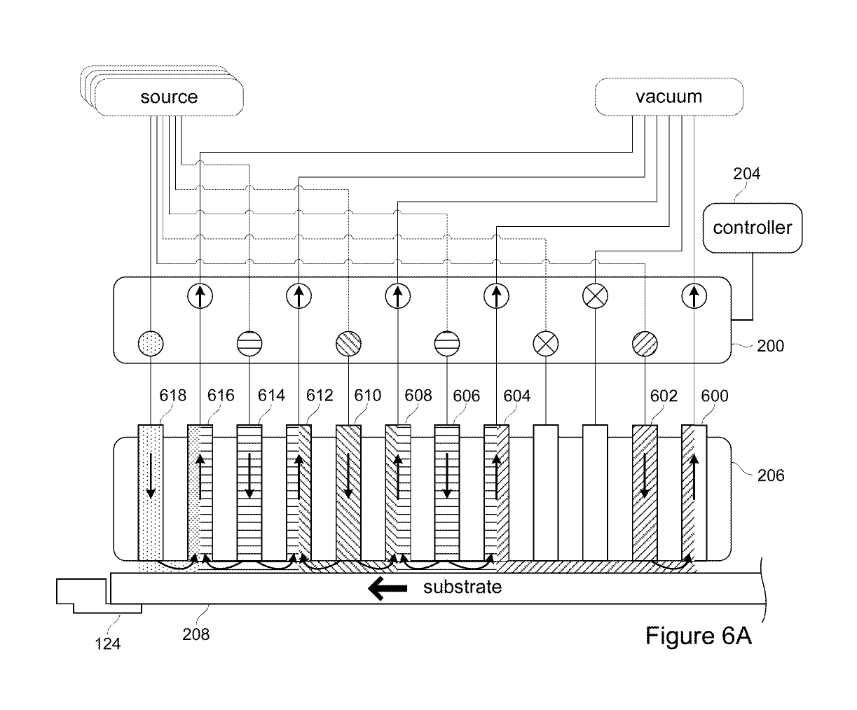

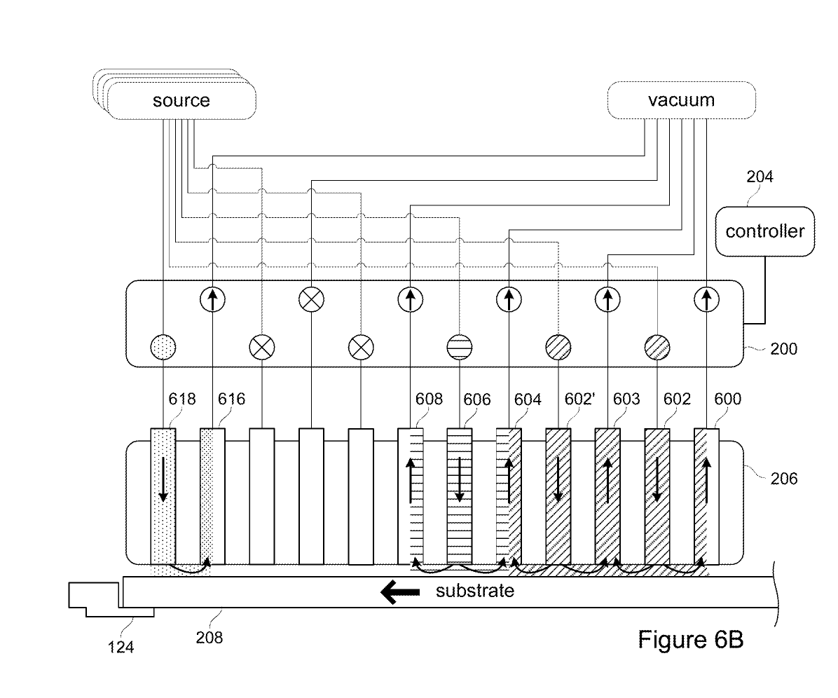

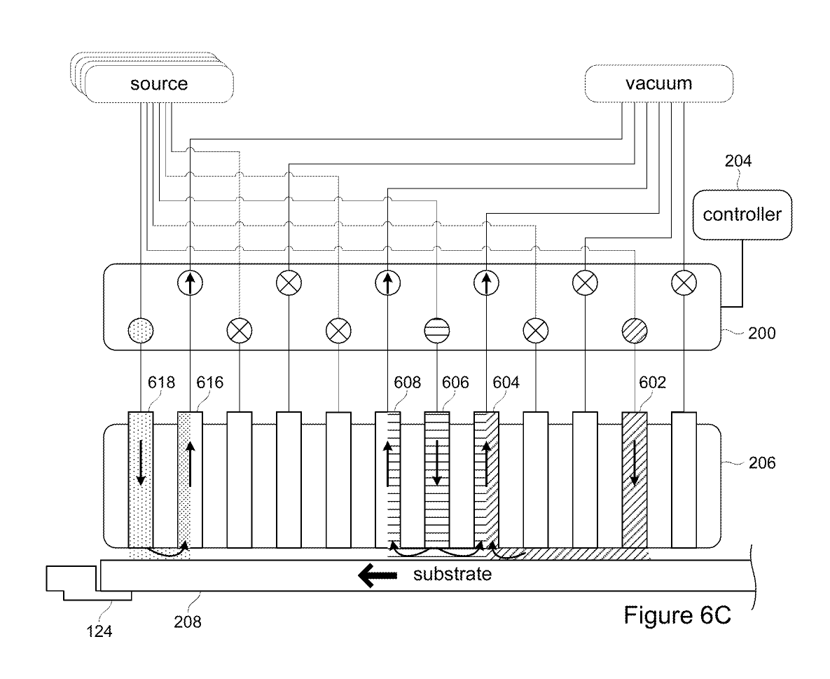

FIG. 6A is a schematic showing the application of multiple process mixtures with different process mixture exposure times using a proximity head 206 with a programmable distribution manifold 200 in accordance with one embodiment of the present invention. The substrate 208 passes into the proximity head 206 and is exposed to removal port 600. Following removal port 600 is dispensing port 602 that dispenses a first process mixture to the surface of the substrate 208. The removal port 600 can prevent the first process mixture from exiting the proximity head 206 across the surface of the substrate 208. After exposing the surface of the substrate to the first process mixture for a period of time determined by the speed of the substrate 208, removal port 604 vacuums the first process mixture from the substrate 208. The substrate 208 can be rinsed by de-ionized water from dispensing port 606. Removal ports 604 and 608 can be used to contain the output of the de-ionized water port 606.

After passing the removal port 608 the substrate 208 can be exposed to a second process mixture from dispensing port 610. The second process mixture can be vacuumed from the substrate 208 using both removal ports 608 and 612. After passing removal port 612 the substrate 208 can be rinsed with de-ionized water from dispensing port 614. Removal ports 612 and 616 can be used to contain the de-ionized water of dispensing port 614. After being rinsed, the substrate 208 can be dried using the output of dispensing port 618. In one embodiment dispensing port 618 outputs a mixture of nitrogen and isopropyl alcohol. In another embodiment, the dispensing port 618 uses compressed carbon dioxide to clean and dry the substrate 208 after rinsing.

FIG. 6B is a schematic illustrating multiple dispensing ports supplying the same process mixture in conjunction with a removal port capable of removing only process mixture in accordance with one embodiment of the present invention. Dispensing ports 602 and 602′ apply a first process mixture to the substrate 208. Removal port 600 removes the first process mixture and air while removal port 603 removes only the first process mixture. In some embodiments, the process mixture removed through removal port 603 can be recycled. Similar to the embodiment shown in FIG. 6A, de-ionized water can be applied to the substrate 208 using dispensing port 606. Removal port 604 can remove a mixture of de-ionized water and the first process mixture while removal port 608 can remove de-ionized water and air. Dispensing port 618 can dispense a mixture to assist in the drying of the substrate 208.

FIG. 6C is a schematic illustrating the containment of process mixture using a single removal port in accordance with one embodiment of the present invention. In this embodiment, the movement of the substrate 208 can help prevent the process mixture dispensed from dispensing port 602 from reaching the exterior of the proximity head 206.

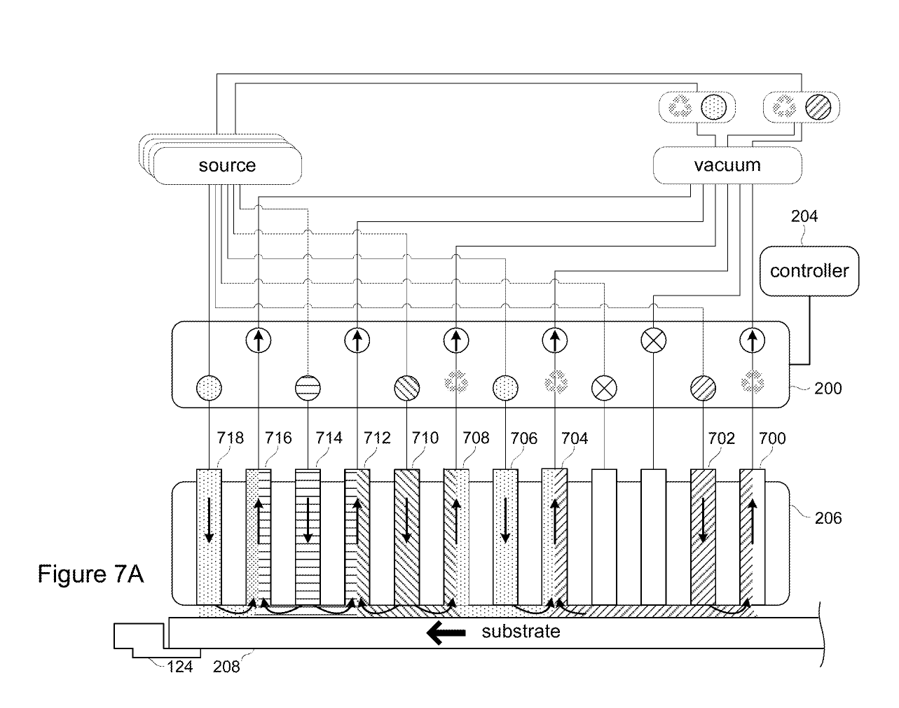

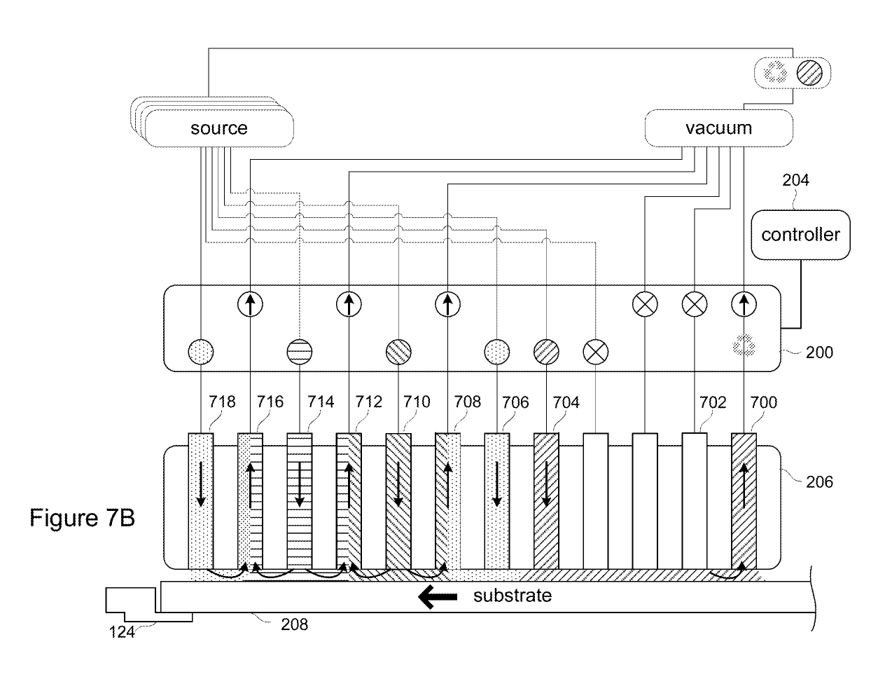

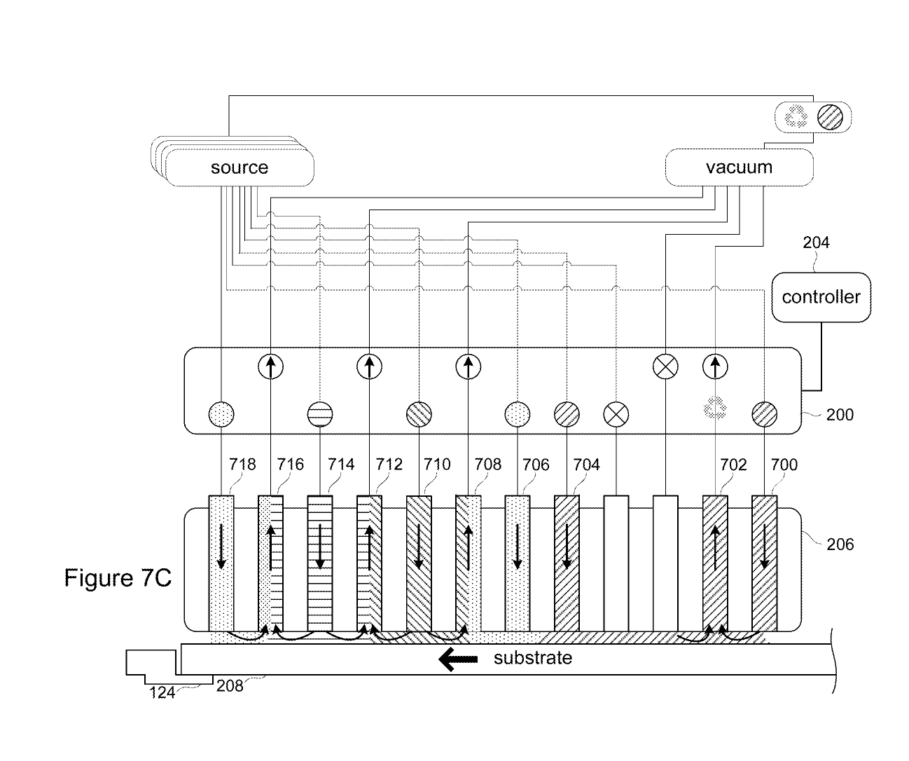

FIG. 7A is a schematic illustrating the application and recycling of multiple process mixtures using a proximity head 206 with a programmable distribution manifold 200 in accordance with one embodiment of the present invention. The substrate 206 enters the proximity head 206 and is exposed to a first process mixture from dispensing port 702. Containing the first process mixture within the proximity head 206 is removal port 700. To reduce the amount of first process mixture consumed by the proximity head 206, the removal port 700 may return the first process mixture removed from the surface of the substrate 208 to the supply. Removal port 704 can stop the reaction between the substrate 208 and the first process mixture by vacuuming the first process mixture from the surface of the substrate 208. After removal port 704, the substrate 208 can be dried using a compressed gas such as nitrogen or carbon dioxide from dispensing port 706. Because an inert gas is applied from dispending sport 706, the first process mixture vacuumed by removal port 704 can also be recycled to the source.

Removal port 708 and removal port 712 can be used to contain a second process mixture that is applied to the substrate 208 through dispensing port 710. The second process mixture vacuumed by removal port 708 can be recycled as removal port 708 removes only the second process mixture and the inert gas from dispensing port 706. After exposure to the second process mixture, the substrate is rinsed using de-ionized from dispensing port 714. Removal port 712 and removal port 716 contain the de-ionized water. In this embodiment, the content vacuumed through removal port 712 is not recycled because removal port 712 vacuum both de-ionized water and the second process mixture. However, in alternate embodiments it may be possible to process the mixture of de-ionized water and second process mixture in order to make it reusable. After rinsing, in one embodiment the substrate 208 is dried using a compressed carbon dioxide from dispensing port 718. In another embodiment, dispensing port 718 applies a mixture of nitrogen and isopropyl alcohol to clean and dry the substrate 208. Note that in FIGS. 4-7C, there are inactive dispensing and vacuum ports. In one embodiment, slight positive pressure of an inert gas can be passed through the inactive ports to prevent wicking of process mixtures into the port. Preventing the wicking or process mixtures into the inactive ports can reduce potential contamination if inactive ports in one process become active during a second process. Furthermore, the application of positive pressure can reduce the cleaning and preparation time necessary to ready the proximity head for the second process.

FIG. 7B an alternate embodiment illustrating the application and recycling of multiple process mixtures using a proximity head 206 with a programmable distribution manifold 200 in accordance with one embodiment of the present invention. A meniscus of process mixture applied to the substrate 208 is contained between removal port 700 and dispensing port 706. In one embodiment, dispensing port 706 can apply a compressed gas such as nitrogen or carbon dioxide to contain the process mixture dispensed from dispensing port 704. In one embodiment, the process mixture from dispensing port 704 can be de-ionized water. In other embodiments, dispensing port 704 can apply a variety of process mixtures that can be contained using gases applied through dispensing port 706. Note that dispensing port 706 can also be used to apply liquid process mixtures to the substrate 208, so long as the process mixtures from dispensing ports 704 and 706 achieve the desired effect on the substrate 208. As removal port 700 can be drawing in both air and the process mixture from dispensing port 704, the process mixture can be recycled. The remainder of the dispensing and removal ports 710-718 remain unchanged from those described in FIG. 7A.

FIG. 7C is an alternate embodiment illustrating the application and recycling of multiple process mixtures using a proximity head 206 with a programmable distribution manifold 200 in accordance with one embodiment of the present invention. In this embodiment, dispensing ports 700 and 704 are used to define a meniscus of a first process mixture on the substrate 208. Note that removal port 702 is used to remove the process mixture dispensed by dispensing port 700 and dispensing port 704. Dispensing port 706 can apply additional process mixtures to the substrate 208 such as carbon dioxide gas or de-ionized water or a mixture thereof Note that the application of de-ionzied water may affect the ability to recycle the process mixture removed via removal port 708. The remainder of the dispensing and removal ports 710-718 remain unchanged from those described in FIG. 7A.

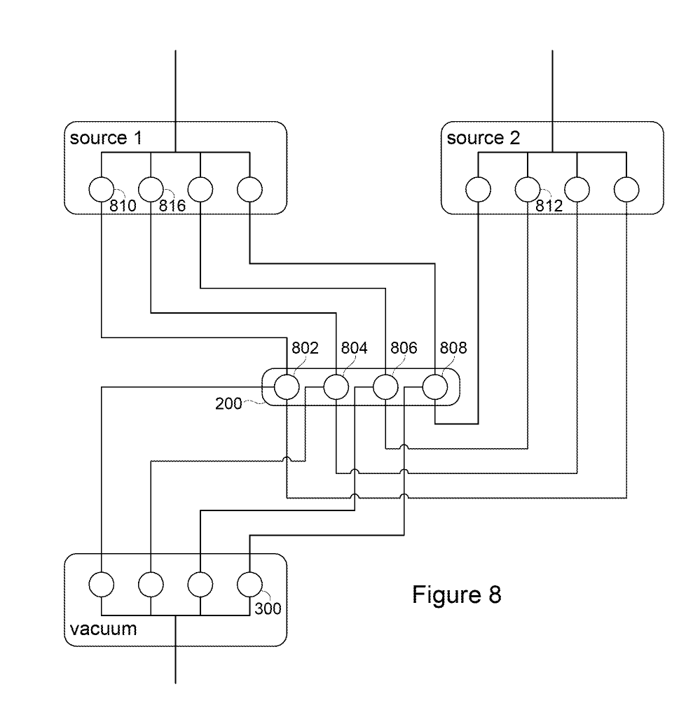

FIG. 8 illustrates an exemplary configuration of using port actuators between the source inputs and the programmable distribution manifold 200 in accordance with one embodiment of the present invention. Programmable distribution manifold 200 is shown with four port actuators 802, 804, 806 and 808. Each of the port actuators in the programmable distribution manifold 200 may be connected to port actuators within source 1, source 2 and vacuum using port conduits. Note that a limited number of port actuators within the sources, vacuum and programmable distribution manifold are shown for sake of simplicity and FIG. 8 should not be considered limiting. The port actuators 802, 804, 806 and 808 can be connected to the proximity head using port conduits to dispense a variety of process mixtures to a substrate.

For simplicity, the controller is not shown in FIG. 8. However, the controller can direct the operation of the port actuators in source 1, source 2, the vacuum and the programmable distribution manifold. For example, the controller can direct the opening of port actuator 810 and port actuator 802. This would allow source 1 process mixture to enter the proximity head. Similarly the controller can direct the opening of port actuator 812 and port actuator 806 to allow process mixture from source 2 to enter the proximity head. Note that opening port actuator 816 and port actuator 804 can allow process mixture from source 1 to enter the proximity head through two adjacent ports. Opening port actuator 814 and port actuator 808 would allow a vacuum to be drawn through the corresponding port in the proximity head.

As multiple source materials may be connected to one port actuator of the programmable distribution manifold, mixing of source materials within the port conduit connecting the programmable distribution manifold and the proximity head is possible. Various ratios of source material may be used in a mixture, as the controller can control flow rate of source materials through the port actuators. Additionally, port conduits can have auto mixing turbulence-creating structures to ensure proper mixing of the source materials.

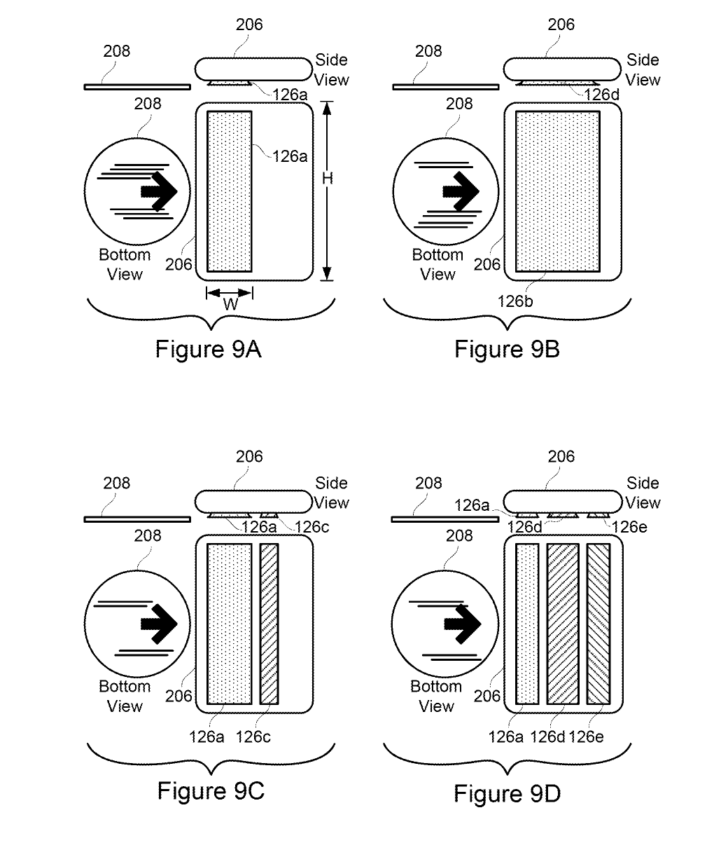

FIGS. 9A-9D illustrate various configurations of menisci using various process mixtures in accordance with embodiments of the present invention. The substrate 208, the proximity head 206 and menisci 126a-126e are shown from the side and from the bottom. For simplicity, in the side views, the menisci 126a-126e are shown as if they are formed between the substrate and the proximity head despite the substrate 208 not having entered the proximity head 206. The different menisci 126a-126e can be created using a single proximity head connected to a controller and programmable distribution manifold. The controller can open various port actuators allowing process mixtures to be supplied to various ports within the programmable distribution manifold and proximity head. The width, W, between the ports which contain the process mixture determines the menisci exposure zones. Increasing or decreasing the speed of the substrate 208 can change the exposure time of the substrate 208 to the menisci. Alternatively, if the speed of the substrate 208 is kept constant, increasing or decreasing the menisci width can alter the exposure time of the substrate 208.

Comparing FIG. 9A and FIG. 9B, meniscus 126a is narrower than meniscus 126b because the distance between the ports within the programmable distribution manifold which contain the meniscus is smaller. In one embodiment, active, or open, removal ports contain the meniscus width. In each case there may be multiple supply and returns within the meniscus width. Therefore, if the respective substrates are moving at the same speed, the substrate 208 of FIG. 9B will be exposed to the meniscus 126b longer than the substrate 208 of FIG. 9B will be exposed to the meniscus 126a. However, the exposure time of the respective substrates may be made equal by moving the substrate 208 of FIG. 9B faster than substrate 208 of FIG. 9A. Similarly, moving the substrate 208 of FIG. 9A slower than the substrate 208 of FIG. 9B can result in equal exposure times within the respective menisci despite the difference in widths of the menisci. In another embodiment, instead of changing the speed of the substrate to effectuate changes in exposure time, additional proximity head ports can dispense process mixture to the substrate 208 by opening additional port actuators of the programmable distribution manifold.

FIG. 9C shows a proximity head 206 can dispense multiple process mixtures to the substrate 208 in accordance with one embodiment of the present invention. Meniscus 126c can be a different process mixture than meniscus 126a. Additionally, the unutilized ports adjacent to the meniscus 126c can be used in conjunction with the programmable distribution manifold and controller to change the width of menisci 126a and 126c. For example, if the substrate 208 requires additional exposure time to meniscus 126a, the controller and programmable distribution manifold can shift the meniscus 126c allowing the width of meniscus 126a to be increased. If the substrate 208 requires additional exposure time to meniscus 126c, the programmable distribution manifold can dispense additional process mixture to the unused ports adjacent to meniscus 126c thereby widening the meniscus 126c.

FIG. 9D is a further illustration demonstrating how three process mixtures can be dispensed to the substrate 208 in accordance with one embodiment of the present invention. The width of each menisci 126a, 126d and 126e can be adjusted using the techniques previously discussed. Note that in FIG. 9A-FIG. 9D instead of a meniscus, the same ports of the proximity head could be used to draw a vacuum.

Although proximity heads were defined for the purpose of fluid delivery, the fluid may be of different types. For instance, the fluids may be for plating metallic materials. Example systems and processes for performing plating operations are described in more detail in: (1) U.S. Pat. No. 6,864,181, issued on Mar. 8, 2005; (2) U.S. patent application Ser. No. 11/014,527 filed on Dec. 15, 2004 and entitled “WAFER SUPPORT APPARATUS FOR ELECTROPLATING PROCESS AND METHOD FOR USING THE SAME”; (3) U.S. patent application Ser. No. 10/879,263, filed on Jun. 28, 2004 and entitled “METHOD AND APPARATUS FOR PLATING SEMICONDUCTOR WAFERS”; (4) U.S. patent application Ser. No. 10/879,396, filed on Jun. 28, 2004 and entitled “ELECTROPLATING HEAD AND METHOD FOR OPERATING THE SAME”; (5) U.S. patent application Ser. No. 10/882,712, filed on Jun. 30, 2004 and entitled “APPARATUS AND METHOD FOR PLATING SEMICONDUCTOR WAFERS”; (6) U.S. patent application Ser. No. 11/205,532, filed on Aug. 16, 2005, and entitled “REDUCING MECHANICAL RESONANCE AND IMPROVED DISTRIBUTION OF FLUIDS IN SMALL VOLUME PROCESSING OF SEMICONDUCTOR MATERIALS”; and (7) U.S. patent application Ser. No. 11/398,254, filed on Apr. 4, 2006, and entitled “METHODS AND APPARATUS FOR FABRICATING CONDUCTIVE FEATURES ON GLASS SUBSTRATES USED IN LIQUID CRYSTAL DISPLAYS”; each of which is herein incorporated by reference.

Other types of fluids may be non-Newtonian fluids. For additional information regarding the functionality and constituents of Newtonian and non-Newtonian fluids, reference can be made to: (1) U.S. application Ser. No. 11/174,080, filed on Jun. 30, 2005 and entitled “METHOD FOR REMOVING MATERIAL FROM SEMICONDUCTOR WAFER AND APPARATUS FOR PERFORMING THE SAME”; (2) U.S. patent application Ser. No. 11/153,957, filed on Jun. 15, 2005, and entitled “METHOD AND APPARATUS FOR CLEANING A SUBSTRATE USING NON-NEWTONIAN FLUIDS”; and (3) U.S. patent application Ser. No. 11/154,129, filed on Jun. 15, 2005, and entitled “METHOD AND APPARATUS FOR TRANSPORTING A SUBSTRATE USING NON-NEWTONIAN FLUID”; each of which is incorporated herein by reference.

Another material may be a tri-state body fluid. A tri-state body is one that includes one part gas, one part solid, and one part fluid. For additional information about the tri-state compound, reference can be made to patent application Ser. No. 60/755,377, filed on Dec. 30, 2005 and entitled “METHODS, COMPOSITIONS OF MATTER, AND SYSTEMS FOR PREPARING SUBSTRATE SURFACES”. This Patent Application was incorporated herein by reference.

The programmable distribution manifold, proximity head and controller may be controlled in an automated way using computer control. Thus, aspects of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, Network Attached Storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for processing a substrate, comprising operations of:
positioning a surface of a head proximate to a surface of the substrate, wherein the surface of the head has a length and a plurality of ports that are configured in rows along the length of the head and wherein each row of ports can deliver a fluid to the surface of the substrate or deliver a vacuum to remove the fluid from the surface of the substrate; and
controlling delivery of the fluid to one or more selected rows and delivery of the vacuum to one or more selected rows so that at least one meniscus is formed whose width depends on a desired exposure time of the meniscus to the surface of the substrate for a particular speed of relative movement between the head and the substrate.

2. A method as in claim 1, wherein each port is associated with a port actuator.

3. A method as in claim 2, wherein delivery of the fluid or vacuum by a port is controlled by activation of the port actuator associated with the port.

4. A method as in claim 3, wherein the activation is performed by a controller.

5. A method as in claim 4, wherein the controller performs the activation based on feedback.

6. A method as in claim 1, wherein at least two meniscuses are formed.

7. A method as in claim 6, wherein the two meniscuses vary with respect to width.

8. A method as in claim 6, wherein the two meniscuses vary with respect to fluid.

9. A method for processing a substrate, comprising operations of:
positioning a surface of a head proximate to a surface of the substrate, wherein the surface of the head has a length and a plurality of ports that are configured in rows along the length of the head and wherein each row of ports can deliver a fluid to the surface of the substrate or deliver a vacuum to remove the fluid from the surface of the substrate;
and controlling delivery of the fluid to one or more selected rows and delivery of the vacuum to one or more selected rows so that at least one meniscus is formed.

10. A method as in claim 9, wherein each port is associated with a port actuator.

11. A method as in claim 10, wherein delivery of the fluid or vacuum by a port is controlled by activation of the port actuator associated with the port.

12. A method as in claim 11, wherein the activation is performed by a controller.

13. A method as in claim 12, wherein the controller performs the activation based on feedback.

14. A method as in claim 9, wherein at least two meniscuses are formed.

15. A method as in claim 14, wherein the two meniscuses vary with respect to width.

16. A method as in claim 14, wherein the two meniscuses vary with respect to fluid.

17. A method for processing a substrate, comprising operations of:
positioning a surface of a head proximate to a surface of the substrate, wherein the surface of the head has a length and a plurality of ports that are configured in rows along the length of the head and wherein each row of ports can deliver a fluid to the surface of the substrate or deliver a vacuum to remove the fluid from the surface of the substrate; and
controlling delivery of the fluid to one or more selected rows which are contiguous and delivery of the vacuum to one or more selected rows which are contiguous so that at least one meniscus is formed whose width depends on a desired exposure time of the meniscus to the surface of the substrate for a particular speed of relative movement between the head and the substrate.

18. The method of claim 17, wherein delivery of the fluid and the vacuum occurs only after the surface of the head is positioned proximate to the surface of the substrate.

19. A method as in claim 17, wherein at least two meniscuses are formed.

20. A method as in claim 19, wherein the two meniscuses vary with respect to width or fluid.
